(19) United States
(12) Patent Application Publication
(10) Pub. No.: US 2018/0111155 A1
(43) Pub. Date: Apr. 26, 2018

(54) Cartridge Piston Having a Vent Valve

(71) Applicant: Ritter GmbH, Schabmuenchen (DE)

(72) Inventor: Frank Ritter, Eppishausen-Weiler (DE)

(73) Assignee: Ritter GmbH, Schabmuenchen (DE)

(21) Appl. No.: 15/782,122

(22) Filed: Oct. 12, 2017

(30) Foreign Application Priority Data
Oct. 21, 2016 (DE) 20 2016 006 508.5

(51) Int. Cl. B05C 17/005

(52) U.S. Cl. CPC B05C 17/00579

(57) ABSTRACT

A cartridge piston has a venting valve and a valve part that is inserted into a front-side recess of the piston, the recess comprising a through opening and a surrounding annular groove. The valve part consists of a central body passing through said through opening and has a projection coacting with a sealing edge and protruding over the back side of the piston. The valve part also consists of a double-walled wall body located in the annular groove and connected to the central body by a front wall, wherein a venting path passes from the piston front side through an air passage into an interspace of the wall body and a filter path formed between an annular wall of the wall body and an annular wall part of the piston provided between said through opening and said groove, and through an annular gap between said wall part and said central body to said sealing edge.

This application claims the priority of Germany Patent Application No. 20 2016 006 508.5, filed Oct. 21, 2016, which is incorporated by reference herein in its entirety.

The present invention relates to a cartridge piston having a vent valve. The invention is applicable to both normal pistons and ring pistons for cartridges containing pasty masses, which can have only one chamber or two concentrically arranged chambers. The vent valve is used to let the air between the piston and the filling material escape through the open rear end of the cartridge when the piston is inserted into the open rear end of the cartridge filled with the filling material; at the same time it should prevent the filling material or components of the filling material, like penetrating oils, from escaping through the vent valve, or prevent air from entering through the venting valve and from reaching the filling material later in the process. This requires that the vent valve remains tightly sealed even after the piston has been inserted, which in turn requires that the valve is not contaminated by particles of the filling material.

### BACKGROUND

A cartridge piston having a vent valve is known from EP 1 207 969 A1. In the arrangement illustrated and described there, a valve part is inserted into a correspondingly adapted opening of the piston, interacts with the piston and forms a valve in cooperation therewith. The valve part has a central body which passes through a through opening of the piston and has a conical region interacting with a sealing edge formed on the piston at the rear end of the piston through bore.

On its front end that is separated from the conical region, the central body is connected to an approximately cylindrical wall body via a front wall region that enters into a correspondingly shaped groove on the front side of the piston and is locked to the radially outer groove wall proximal to the groove base.

The cylindrical wall body of the valve part forms a gap with the radially outer groove wall of the piston groove, which allows air to enter, and the detent is interrupted by several air ducts through which air can pass through and then further pass between the rear end of the cylindrical wall part and the base of the groove.

A filter path with narrow channels is formed between the radially inner groove wall and the cylindrical wall body of the valve part and serves to catch and prevent the filling material of the cartridge passing through the air ducts of the detent mechanism and components like penetrating oils from reaching the valve formed between the conical region of the central body and the sealing lip of the piston. The filter path immediately follows the detent mechanism.

The central body protrudes slightly above the back side of the piston, so that, when a pressure is exerted on the piston at its back, as might be the case when the piston is inserted, the central body is pushed slightly forward, thus opening a venting gap between the conical region of the central body and the sealing edge at the rear end of the piston through opening, through which venting air can escape. When pressure is no longer exerted on the back side of the piston, the valve closes again since the wall region connecting the front side of the central body to the cylindrical wall body is configured in such a way that it acts as a spring that biases the central body in the rearward direction and compresses it with its conical region in cooperation with the sealing edge of the piston through opening, and thus keeps the valve closed.

It is however a disadvantage of the known arrangement that the filling material of the cartridge entering through the gap between the cylindrical wall body and the radially outer groove wall can clog the air ducts of the detent mechanism and thus obstruct the venting, or that material penetrating through the detent mechanism can clog the filter path immediately following the detent mechanism. Venting will then no longer be possible, which leaves residual air between the piston and the filling material; this is generally undesirable since chemical reactions or other impairments of the filling material might occur.

### SUMMARY

It is therefore an object of the invention to provide a cartridge piston having a venting valve, the venting function of which is improved and offers a greater degree of safety for a complete venting.

According to the present invention, this object is achieved by the arrangement indicated in claim 1.

Advantageous embodiments of the invention are the subject matter of the dependent claim.

According to the invention, the venting no longer occurs through the detent of the cylindrical wall body in the piston, and also not via the annular gap between the cylindrical wall body and the radially outer groove wall. Rather, the cylindrical wall body is configured with a larger radial thickness and with double walls, with the two walls forming a relatively large interspace between them which opens towards the rear and is closed at the front.

However, small air passage openings are provided in the wall region of the wall body closing off the interspace at the front, through which openings the air to be vented can enter the interspace between the two walls of the cylindrical wall body. Between the radially inner wall of the cylindrical wall body and the radially inner groove wall, a filter path with narrow channels is formed and can trap material entering through the air passage openings.

From the interspace between the two walls of the cylindrical wall body, air to be vented passes, flowing again in the forward direction, between the inner wall of the wall body and the radially inner groove wall through the filter path formed therebetween, and then flows, now again diverted into the backward direction, through an annular gap between the central body and the piston opening wall, and finally exits through the opened valve gap between the conical region of the central body and the sealing edge of the piston through opening.

### BRIEF DESCRIPTION OF THE DRAWING

FIG. 1 is an axial, cross-sectional view of a piston having a vent valve as described herein.

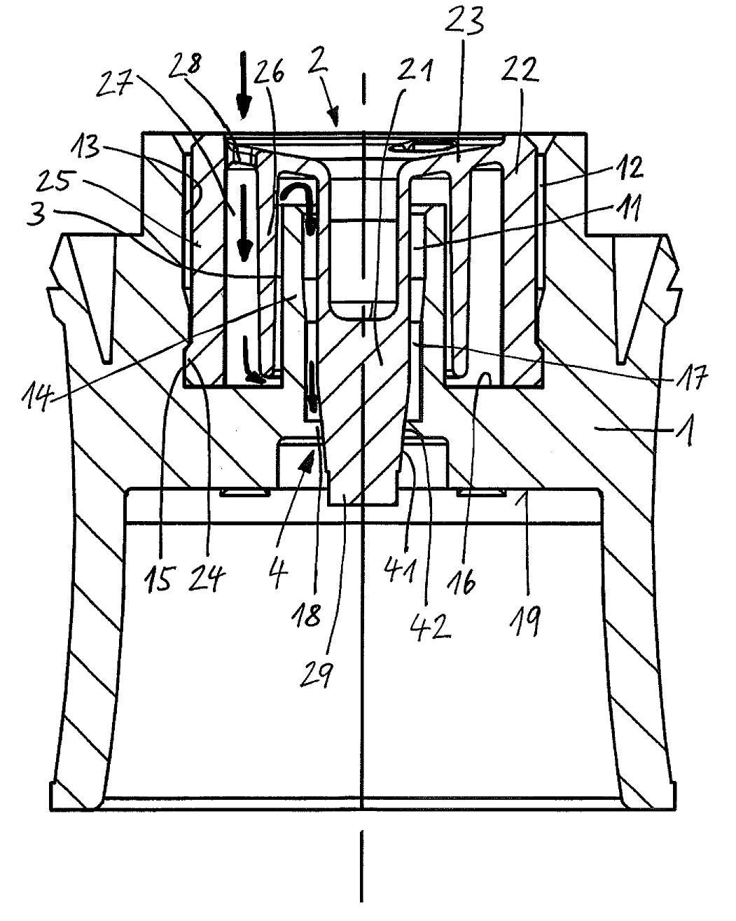

### DETAILED DESCRIPTION

An example embodiment of the invention will now be described in more detail with reference to the accompanying drawing that shows an axial cross-section of a piston having a vent valve according to the invention.

The accompanying drawing shows an axial cross-section of a piston having a venting valve according to the invention. A valve part 2 is inserted into the piston 1 from its front side, into a corresponding recess of the piston.

The recess of the piston 1 used to accommodate the valve part 2 consists of a through opening 11 and an annular groove 12 concentrically surrounding the opening.

In the drawing, the piston front side is seen at the top, and the piston back side is seen at the bottom. All directional expressions in the following refer to this state.

The valve part 2 consists of a central body 21 extending through the through opening 11 of the piston, an approximately cylindrical wall body 22 concentrically surrounding the central body 21 and entering into the annular groove 12, and a wall region 23 connecting the central body 21 to the cylindrical wall body 22 on the front side of the piston.

The annular groove 12 that accommodates the cylindrical wall body 22 of the valve part 2 is delimited radially outwardly by an outer groove wall 13, and radially inwardly by an approximately cylindrical wall part 14 of the piston 1 which separates the annular groove 12 from the through hole 11.

The cylindrical wall body 22 of the valve part 2 is positively fixed in place on the piston by a locking mechanism in the annular groove 12, with locking elements 24 at the rear end of wall body 22 locking with an undercut 15 of the outer annular groove wall 13 close to the groove base 16.

The cylindrical wall body 22 of the valve part 2 presents a double-walled configuration and has an outer cylindrical wall 25 and an inner cylindrical wall 26 which define an interspace 27 in the form of a cylindrical ring therebetween; the interspace opens towards the rear end (or the bottom end in the drawing) of the valve part 2 and is closed at the front end (or upper end in the drawing) of the valve part 2 by the wall region 23. The wall region 23 is perforated by several small air passage openings distributed around its periphery 28, the openings leading from the front face of the valve part into the interspace 27.

Between itself and the annular wall part 14, the inner wall 26 of the wall body 22 forms a filter path 3 formed by narrow channels that allow air but no material to pass through. The length of the annular wall part 14 is dimensioned in such a way that an interspace remains between its front end and the wall region 23.

Between its peripheral surface and the inner peripheral surface of the piston through opening 11, the central body 21 of the valve part 2 forms an annular gap 17 through which air to be vented can flow.

The actual valve 4 is formed by a conical lateral surface region 41 of the central body in cooperation with a sealing edge 42 of a protrusion 18 of the opening wall which protrudes radially inwards, at the rear end of the piston passage opening 11. The valve part as a whole is configured in such a way that the wall region 23 acts as a spring that biases the central body 21 towards the piston back side, relative to the outer wall 25 of the cylindrical wall body 22 that is locked within the piston, in such a way that the central body 21 with its conical peripheral surface region 41 is pressed against the sealing edge 42 of the opening wall protrusion 18 in order to close the valve 4 tightly.

On its rear end, the central body 21 has a pin-like projection 29 which protrudes above the back side of the piston 19. If a pressure is exerted against the back side of the piston, as would be the case when the piston is inserted into a cartridge, the pin-like projection 29 is pressed forward, thereby opening a valve gap between the conical peripheral surface region 41 of the central body 21 and the sealing edge 42 of the opening wall projection, through which air to be vented can escape. When the pressure is removed from the back side of the piston, the central body resiliently moves backwards again and closes the valve gap in cooperation with the sealing edge 42.

Upon introduction of the piston, air from the rear region of the cartridge between the filling mass and the piston front side enters through the air passage openings 28 into the interspace 27 between the outer wall 25 and the inner wall 26 of the wall body 22. The flow path of the air during the venting process is indicated by arrows. The inner wall 26 of the wall body 22 is slightly shorter than the outer wall 25 mounted on the groove base 16 of the annular groove 12, so that air entering the interspace 27 can flow around the rear end edge of the inner wall 26 and into and through the filter path 3 between the inner wall 26 and the annular wall part 14. It then passes around the leading edge region of the annular wall part 14 through the interspace between the latter and the wall region 23 and into the annular gap between the central body 21 and the annular wall part 14, where the air then flows through this annular gap and can finally exit from the open valve gap.

1. A cartridge piston having a venting valve, wherein:
a valve part is inserted into a front-side recess of the piston, the recess comprising a through opening and an annular groove surrounding the opening,
the valve part consists of a central body passing through the through opening of the piston, and a wall body surrounding it at a distance, the wall body entering into the annular groove and being connected to the central body at the front side of the piston by a wall region,
the central body is separated by an annular gap between itself and an annular wall part of the piston separating the through opening from the annular groove, and has a conical peripheral surface region tapering towards the back that and cooperating with a sealing edge of an opening wall projection formed in the through opening,
the central body has at its rear end a projection protruding over the back side of the piston, over which projection the central body can be pushed forward upon a pressure being exerted on the back side of the piston against a returning force generated by the wall region that acts as a spring, in order to open a valve gap between the conical peripheral surface region and the sealing edge,
a venting path is provided that passes through the annular groove, and a filter path formed between the wall body and the annular wall part, as well as through the annular gap,
wherein the wall body has a double-walled configuration having an outer wall and an inner wall between which an interspace is formed, the interspace being closed at the front end by the wall region which is only penetrated by at least one air passage opening leading from the piston front side into the interspace,
and in that between the inner wall and the annular wall part the filter path is formed, into which air can enter from the interspace around the rear end of the inner wall and can enter the annular gap from the filter path around the front end of the annular wall part.

2. The piston having a venting valve according to claim 1, wherein the valve part is locked in the annular groove by a locking between the outer circumference of the outer wall of the wall body and the outer annular groove wall.
